(19) United States
(12) Patent Application Publication
(10) Pub. No.: US 2008/0184578 A1
(43) Pub. Date: Aug. 7, 2008

(54) Construction tool

(76) Inventor: Michael Gary O'Brien, San Jose, CA (US)

Correspondence Address: MICHAEL GARY O'BRIEN, 2202 HIKIDO DR, SAN JOSE, CA, 95131, US

(21) Appl. No.: 11/529,721

(22) Filed: Feb. 6, 2007

(51) Int. Cl. G01B 3/56

(52) U.S. Cl. 33/535

(57) ABSTRACT

A construction tool for stud wall positioning comprising two (2) members of unequal lengths. The shorter member serving as a base with one (1) end abutting the bottom of the stud frame and configured with an adapter cap. The opposite end is configured to act as a female part for the male end of the second member. The opposite end of the second member is placed vertical and diagonally to reach the upper plate of the stud wall frame unit where it connects with a wedge shaped unit that secures the invention to the stud wall frame. The base member offers features to level the inventive device if the floor is not level.

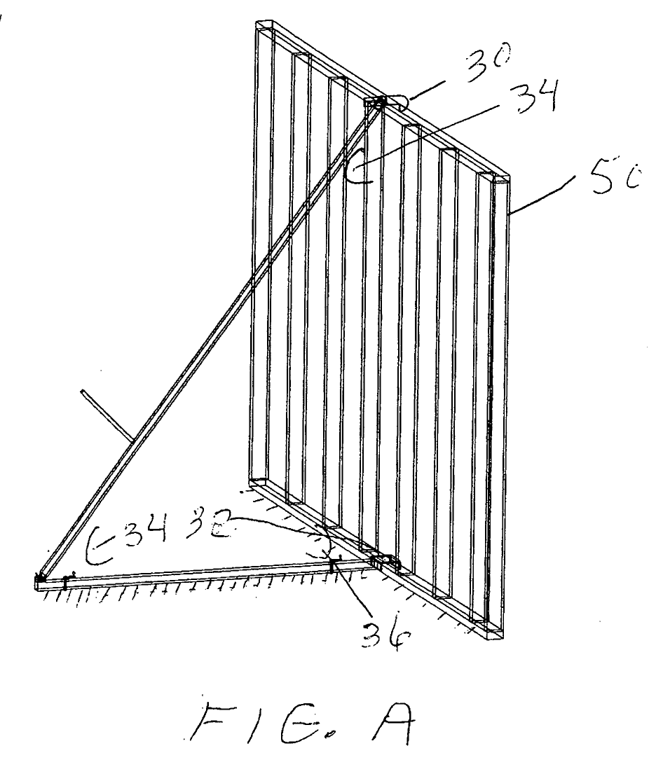

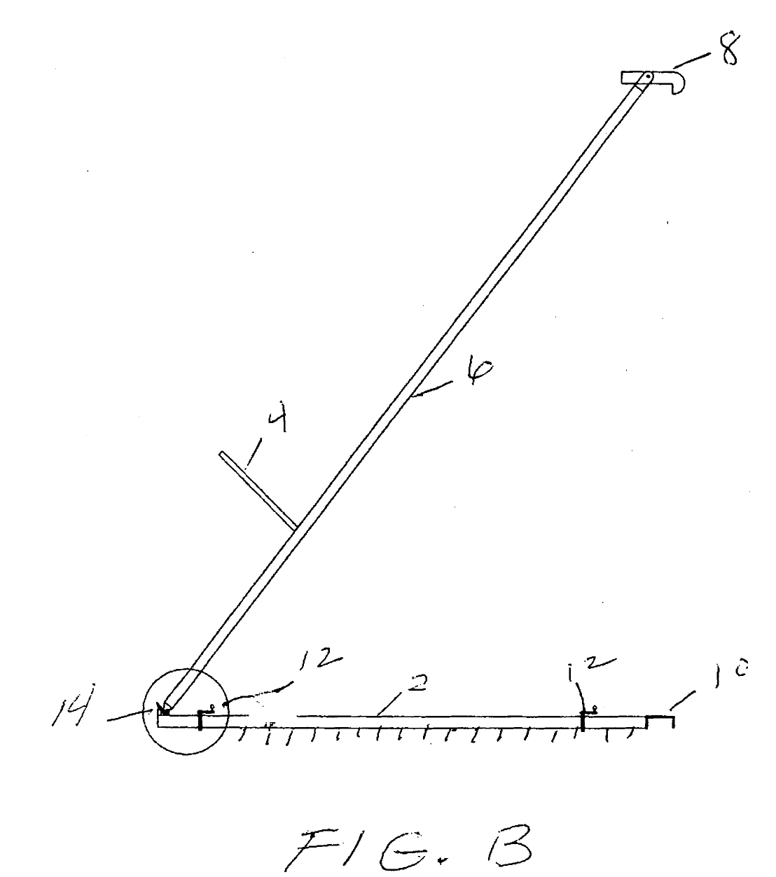

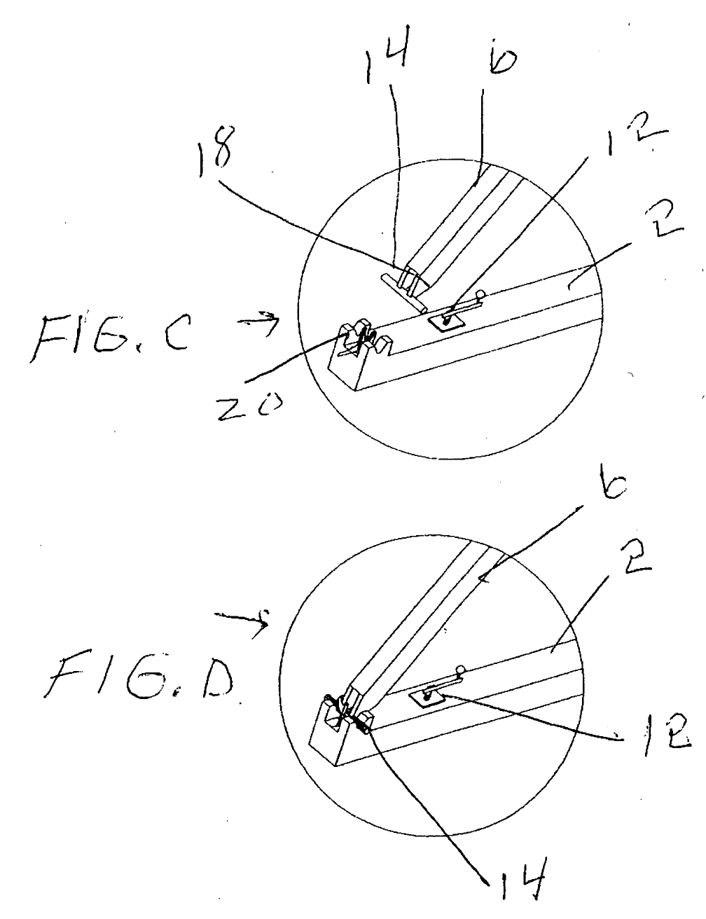

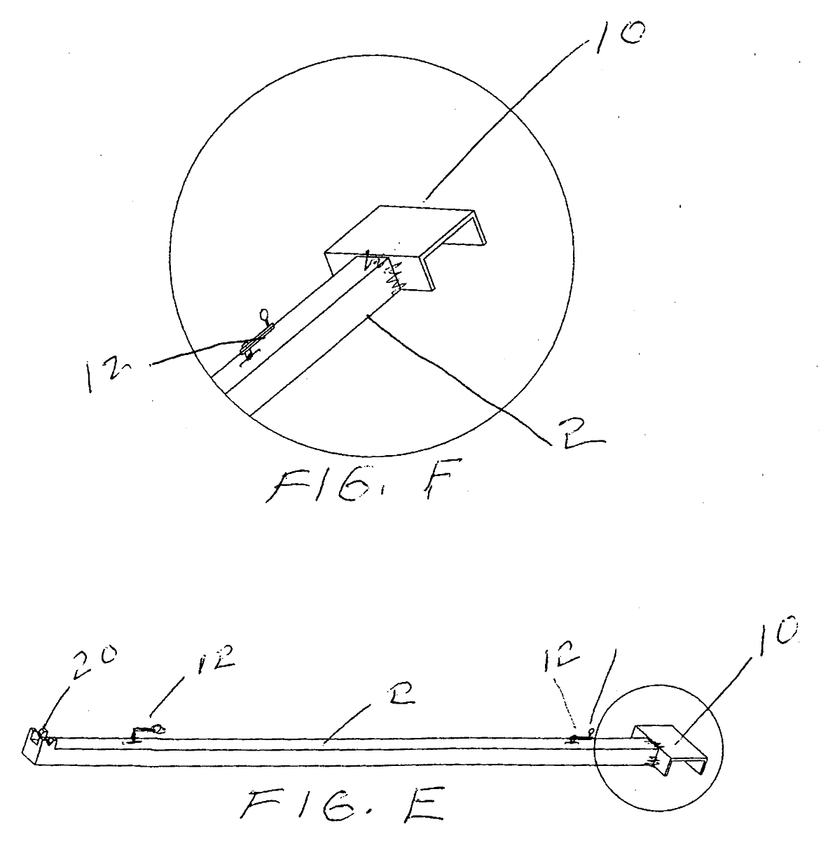

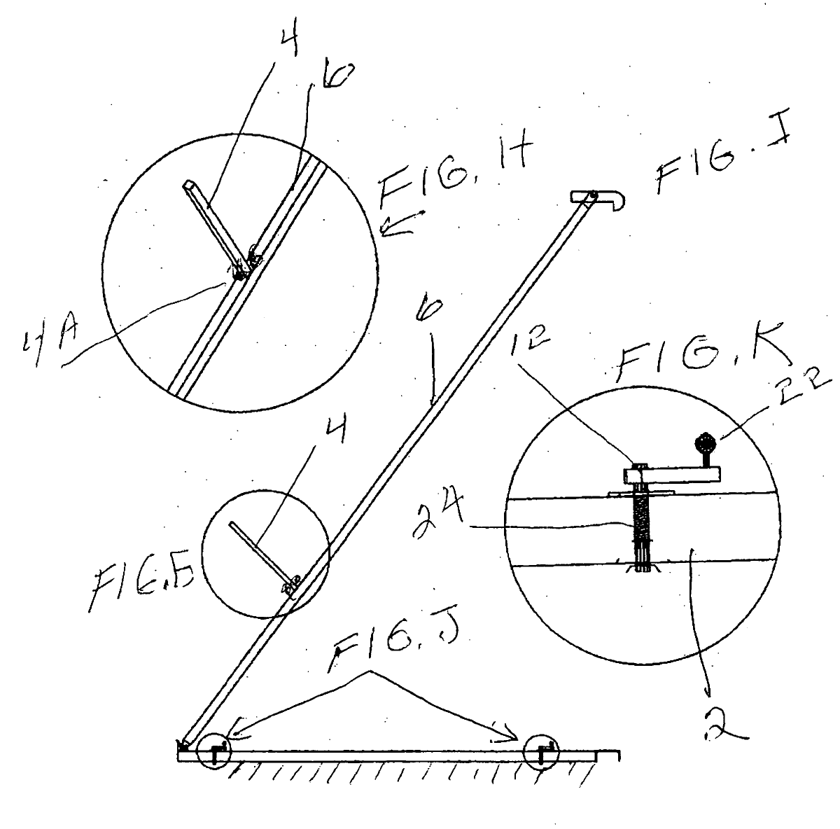

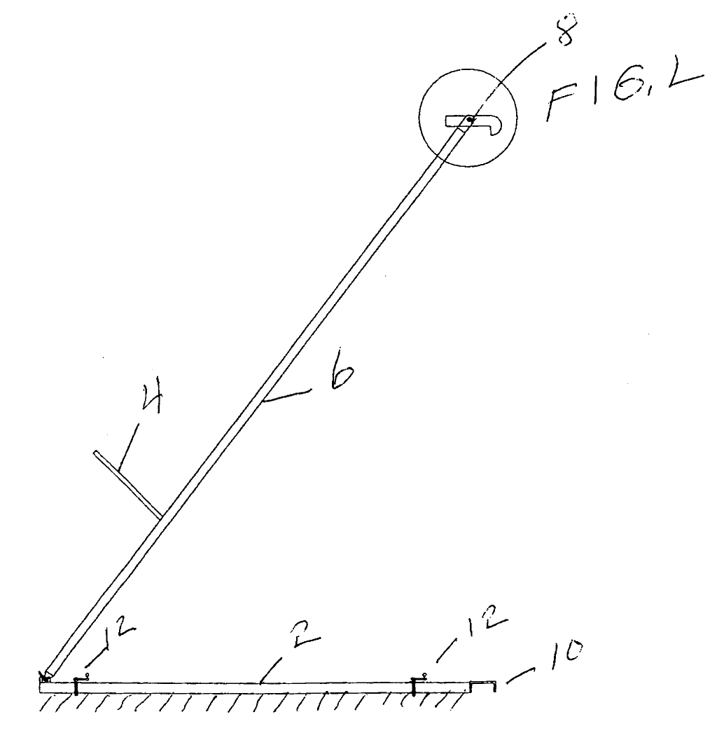

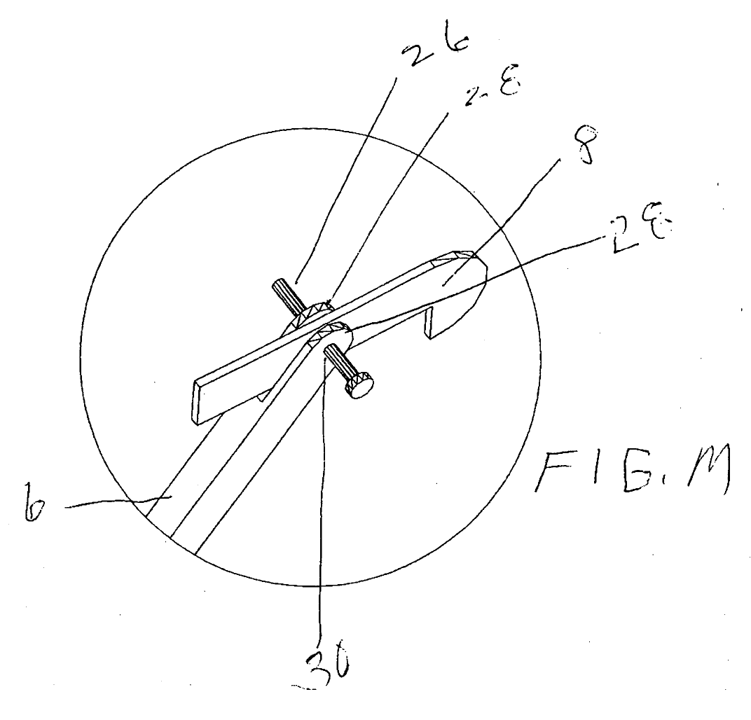

### BACKGROUND OF THE INVENTION

This invention relates generally to a construction tool for the positioning of a finished stud wall framed unit. Present methods of stabilizing and squaring the stud wall frame unit usually requires the efforts of several workers and the pushing and tilting of the unit, then eyeballing and using a plumb line to verify their accuracy. The stud wall is then stabilized by the use of an assortment of support lumber nailed into the studs. This inventive device is simple in construction, inexpensive to manufacture, capable of a long life in use and will save manpower and material.

The invention incorporates the mathematical equation of 3,4,5 (and multiples there of) to create the perfect right angle of 90 degrees at the vertical base eliminating the need for plumbing to create a properly aligned vertical wall.

Another objective of the invention is to stabilize the wall frame as support items are added for temporary placement.

Another feature of this invention is the addition of leveling means in the base member allowing a proper level base on an uneven surface.

### SUMMARY OF THE INVENTION

In general, the invention consists of a tool for positioning and aligning a stud wall framed unit. The construction tool comprises two (2) body members of unequal length. The shorter member provides a base unit structure with leveling and offering a female receptacle for the longer member that is placed vertically and diagonally to the upper top plate for connection to an adaptor that is formatted to cover the top stud plate.

### PRIOR FILINGS

The inventor claims priority of a Provisional Patent Application filed Sep. 23, 2005 No: 60\719-652

### PRIOR ART REFERENCES

The nature of the subject inventive device caused an extensive patent search:

U.S. Pat. Nos. 6,907,675; 6,903,934

U.S. Pat. Nos. 6,880,086; 6,876,652

U.S. Pat. Nos. 6,873,946; 6,868,092

U.S. Pat. Nos. 6,783,051; 6,775,916

U.S. Pat. Nos. 6,760,339; 6,742,134

U.S. Pat. Nos. 6,712,415; 6,708,29

### RELATED PATENTS OF INTEREST

1. U.S. Pat. No. 3,933,348 speaks of a double plating wall framer used in framing walls and is directed to the construction of the stud wall frame. There is no interference with this offered invention as my submission relates to use after the stud unit is constructed.

2. Timmer in U.S. Pat. No. 6,574,897 speaks of a display frame assembly of framing Picture Frames and was found to have no interference with this Patent Application.

3. Butcher; et al. U.S. Pat. No. 5,456,015 speaks of a construction square. Butcher uses a triangular shaped square with a tape measure for measuring distances for a framing layout and the ability to form a right angle. Butcher offers a very complicated series of steps with the base and guides having marked edges and notches to reach right angles. The present invention is capable of attaining the same right angle almost precisely as installed. Butcher does refer to the saving of material and labor as is offered by this inventive submission.

4. Lucia, Jr. U.S. Pat. No. 5,822,942 offers an auxiliary surface forming member construction elements. The stud members are aligned within the offered units attached to a perpendicular base portion. No interference is seen.

### CLOSER RELATED PATENTS

1. Tidwell, Jr. U.S. Pat. No. 3,933,348 offers a double plating wall framer. The instant offered invention could be classified as a double plating item as it does secure the bottom and top stud plates, but only after the framing unit is vertical and ready to be positioned. Tidwell speaks of using a series of criss-cross beams for framing the unit

2. Thibault, U.S. Pat. No. 4,599,779. This patent does contain some features that are found in the present patent offered. Thibault does refer to metal framing elements as opposed to the present invention directed to wood frame elements. Thibault offers a main body portion adapted to the opposite side walls of the framing element with each end having a recess. A closer review of Thibault displays the purpose is limited to metal elements while framing or placing in a vertical position.

The invention having been thus described, what is claimed as now and desired to be secured by letters Patent are:

1. A construction Tool for maintaining a stud wall frame in a stabilized position properly aligned and squared without the use of a plumb line.
a. The tool having a main body comprised of two members. The shorter member abutting the base of the frame has an adaptor to secure the bottom plate. The longer member is attached to the far end of the base member and rising vertically and diagonally to the top plate.
b. There are leveling screws incorporated within the base plate for leveling purposes.

2. Adapters as described for securing the top and bottom plates.

3. The use of the Mathematical equation 3,4,5 to create a squared stud wall.

4. The physical connection as used to join 2 & 6.

5. The connection and design of the device that secures the top plate.
